(19) United States
(12) Patent Application Publication
(10) Pub. No.: US 2023/0148792 A1
(43) Pub. Date: May 18, 2023

(54) GRILL STOVE WITH BAKING STRUCTURE

(71) Applicant: REVOACE INC.LIMITED, Hong Kong (CN)

(72) Inventor: Kiosky Chung, Hong Kong (CN)

(21) Appl. No.: 17/525,845

(22) Filed: Nov. 12, 2021

(51) Int. Cl. A47J 37/01; F24C 15/16; A47J 37/07

(52) U.S. Cl. CPC A47J 37/01; A47J 37/0704; A47J 37/0786; F24C 15/168

(57) ABSTRACT

A grill stove with a baking structure contains a body, and the body includes a support base and a grilling assembly. The support base includes a baking chamber and a rail assembly. The rail assembly includes a first rail, a second rail, and a curved connection rail. The support base has a tray located in the baking chamber, and the tray has four rollers configured to roll on the rail assembly. Two adjacent rollers of the four rollers are arranged on a first side of the tray, and the other two adj acent rollers of the four rollers are arranged on a second side of the tray. The tray further includes a holding portion formed on a top thereof and configured to accommodate the other foods.

### FIELD OF THE INVENTION

The present invention relates to a grill stove with a baking structure which is capable of accommodating some foods in the grilling assembly to grill said some foods, and the other foods are placed on the tray to be baked by using heat of fires from the grilling assembly simultaneously.

### BACKGROUND OF THE INVENTION

Conventional grill is to cook food on the fire until it is edible. Since most meat is cooked, grill is also called barbecue. In modern society, barbecue has become a multi-person gathering leisure and entertainment. With the diversification of barbecues, various grill stoves have appeared on the market for consumers to use. For example, the grill is also used to make PIZZA and other baked dishes.

However, when making PIZZA, the other foods cannot be grilled simultaneously.

The present invention has arisen to mitigate and/or obviate the afore-described disadvantages.

### SUMMARY OF THE INVENTION

The primary aspect of the present invention is to provide a grill stove with a baking structure which is capable of accommodating some foods in the grilling assembly to grill said some foods, and the other foods are placed on the tray to be baked by using heat of fires from the grilling assembly simultaneously.

To obtain the above mentioned aspects, a grill stove with a baking structure provided by the present invention contains a body, and the body includes a support base and a grilling assembly located on the support base and configured to grill some foods.

The support base includes a baking chamber defined in a first end thereof, and a rail assembly formed on two sides of the baking chamber of the support base.

The rail assembly includes a first rail formed on two sides of the first end of the support base, a second rail formed on two sides of a second end of the support base and located higher than the first rail, and a curved connection rail defined between and connected with the first rail and the second rail.

The support base has a tray located in the baking chamber, and the tray has four rollers configured to roll on the rail assembly. Two adjacent rollers of the four rollers are arranged on a first side of the tray, and the other two adj acent rollers of the four rollers are arranged on a second side of the tray.

When the tray is received in the baking chamber, the four rollers are located on the second rail.

When the tray is pulled out of the baking chamber, the four rollers are located on the first rail.

The tray further includes a holding portion formed on a top thereof and configured to accommodate the other foods.

### BRIEF DESCRIPTION OF THE DRAWINGS

FIG. 1 is a perspective view showing the exploded components of a part of a grill stove with a baking structure according to a preferred embodiment of the present invention.

FIG. 2 is a perspective view showing the assembly of the grill stove with the baking structure according to the preferred embodiment of the present invention.

FIG. 3 is a perspective view showing the operation of the grill stove with the baking structure according to the preferred embodiment of the present invention.

FIG. 4 is another perspective view showing the operation of the grill stove with the baking structure according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

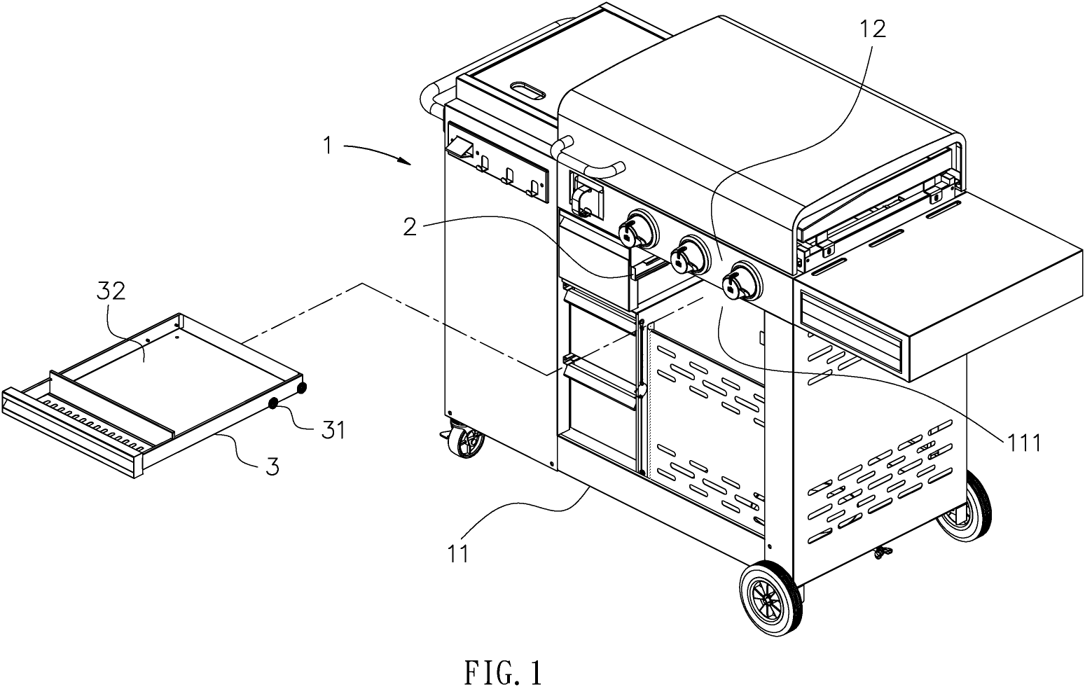

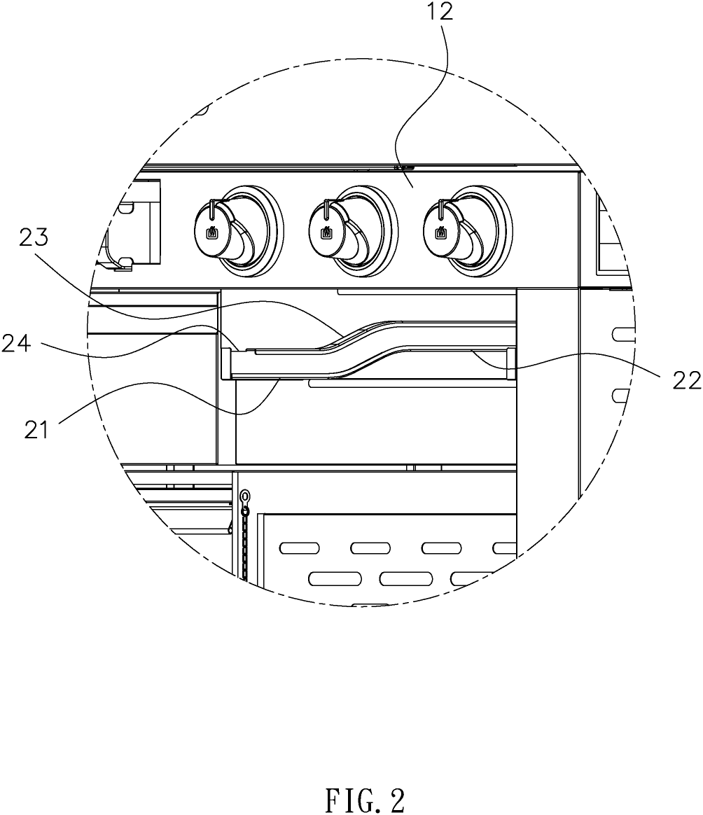

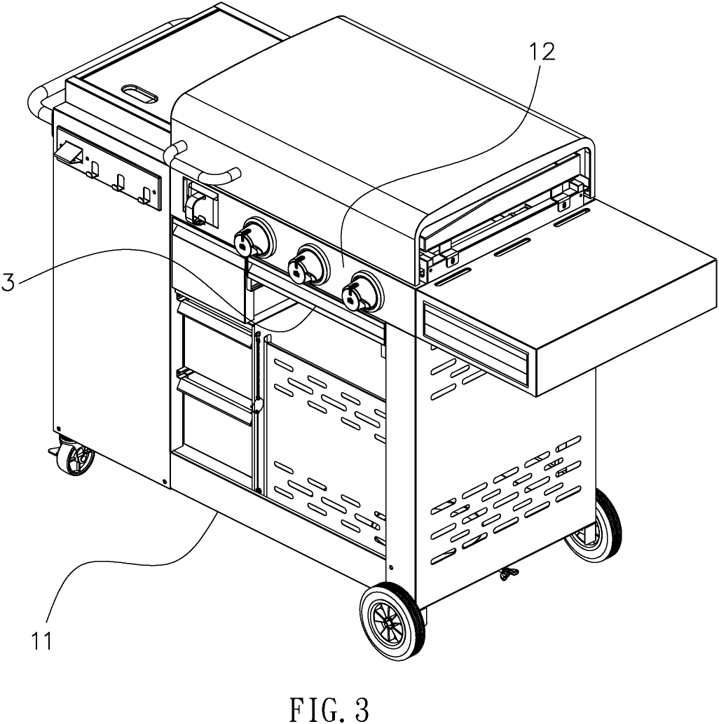

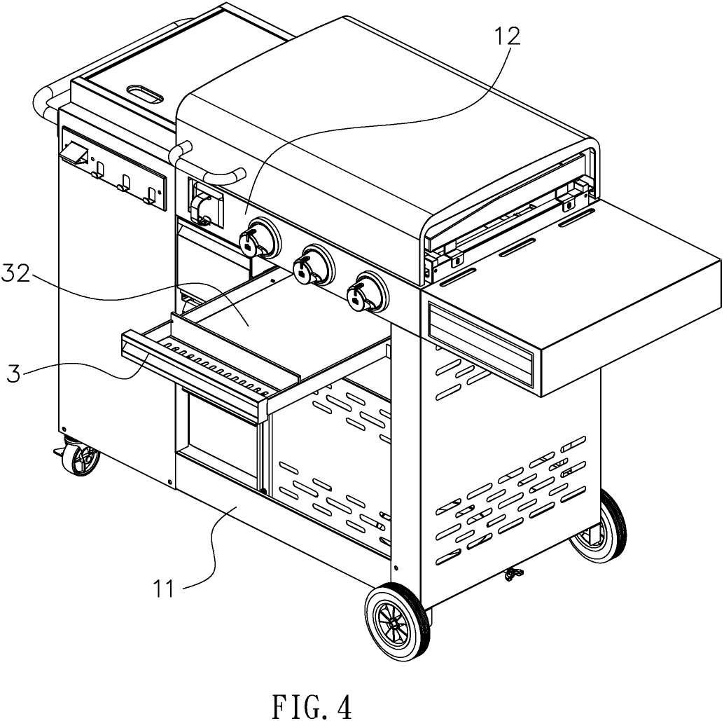

With reference to FIGS. 1-4, a grill stove with a baking structure according to a preferred embodiment of the present invention is capable of baking and grilling various foods simultaneously. The grill stove comprises a body 1, and the body 1 includes a support base 11 and a grilling assembly 12 located on the support base 11 and configured to grill some foods.

The support base 11 includes a baking chamber 111 defined in a first end thereof, and a rail assembly 2 formed on two sides of the baking chamber 111 of the support base 11.

The rail assembly 2 includes a first rail 21 formed on two sides of the first end of the support base 11, a second rail 22 formed on two sides of a second end of the support base 11 and located higher than the first rail 21, and a curved connection rail 23 defined between and connected with the first rail 21 and the second rail 22.

The support base 11 has a tray 3 located in the baking chamber 111, and the tray 3 has four rollers 31 configured to roll on the rail assembly 2, wherein two adjacent rollers 31 of the four rollers 31 are arranged on a first side of the tray 3, and the other two adjacent rollers 3 of the four rollers 3 are arranged on a second side of the tray 3. When the tray 3 is received in the baking chamber 111, the four rollers 31 are located on the second rail 22. When the tray 3 is pulled out of the baking chamber 111, the four rollers 31 are located on the first rail 21. The tray 3 further includes a holding portion 32 formed on a top thereof and configured to accommodate the other foods.

In operation, the other foods are accommodated in the holding portion 32 of the tray 3. When the tray 3 is received in the baking chamber 111, the four rollers 31 are aligned with the second rail 22 so that the tray 3 is lifted slightly to close to the support base 11, thus obtaining a baking effect. When the tray 3 is pulled out of the baking chamber 111, the four rollers 31 are aligned with the first rail 21 so that the tray 3 is descends slightly, thus taking or placing the foods easily.

The first rail 21 of the rail assembly 2 has two openings 24 defined on a top away from the curved connection rail 23 so that the four rollers 31 are placed into or are removed from the opening 24, wherein the tray 3 is detached from the support base 11 via the opening 24 easily to be cleaned.

Thereby, some foods are accommodated in the grilling assembly 12 to be grilled, and the other foods are placed on the tray 3 to be baked by using heat of fires from the grilling assembly 12 simultaneously.

While various embodiments in accordance with the present invention have been shown and described, it is clear to those skilled in the art that further embodiments may be made without departing from the scope of the present invention.

What is claimed is:

1. A grill stove with a baking structure comprising: a body, and the body including a support base and a grilling assembly located on the support base and configured to grill some foods;
wherein the support base includes a baking chamber defined in a first end thereof, and a rail assembly formed on two sides of the baking chamber of the support base;
wherein the rail assembly includes a first rail formed on two sides of the first end of the support base, a second rail formed on two sides of a second end of the support base and located higher than the first rail, and a curved connection rail defined between and connected with the first rail and the second rail;
wherein the support base has a tray located in the baking chamber, and the tray has four rollers configured to roll on the rail assembly, wherein two adjacent rollers of the four rollers are arranged on a first side of the tray, and the other two adjacent rollers of the four rollers are arranged on a second side of the tray;
wherein when the tray is received in the baking chamber, the four rollers are located on the second rail;
wherein when the tray is pulled out of the baking chamber, the four rollers are located on the first rail;
wherein the tray further includes a holding portion formed on a top thereof and configured to accommodate the other foods.

2. The grill stove with the baking structure as claimed in claim 1, wherein the first rail of the rail assembly has two openings defined on a top away from the curved connection rail so that the four rollers are placed into or are removed from the opening.
